(19) United States
(12) Patent Application Publication
(10) Pub. No.: US 2020/0270011 A1
(43) Pub. Date: Aug. 27, 2020

(54) Clamshell Packaging Structure

(71) Applicants: Bouldertog LLC, Bellevue, WA (US); Michael Friton Design LLC, Milwaukie, OR (US)

(72) Inventors: Michael Friton, Portland, OR (US); Nhimy Chung, Bellevue, WA (US)

(73) Assignees: Bouldertog LLC, Bellevue, WA (US); Michael Friton Design LLC, Milwaukie, OR (US)

(21) Appl. No.: 16/286,379

(22) Filed: Feb. 26, 2019

(51) Int. Cl. B65D 5/00; B65D 5/20; B65D 5/42; B65D 85/18; B31B 50/73

(52) U.S. Cl. CPC B65D 5/0085; B65D 5/2057; B31B 2110/35; B65D 85/187; B31B 50/734; B65D 5/4204

(57) ABSTRACT

A box has a total inner volume in a closed configuration. The box includes a first box portion that defines a first inner volume and a second box portion that defines a second inner volume. The second box portion is pivotally coupled to the first box portion along a clamshell hinge. The first and second inner volumes combine to provide the total inner volume with each of the first and second inner volumes providing at least 30 percent of the total inner volume. The first box portion and the second box portion are each formed from a unitary sheet of sheetstock material. The clamshell hinge is a living hinge formed in the sheetstock material.

### FIELD OF THE INVENTION

The present invention relates to boxes, such as clamshell boxes for use with shoes.

### BACKGROUND OF THE INVENTION

Boxes for shoes or food often have clamshell construction. Such boxes for food typically have inclined walls that, when the bases of the boxes are horizontal, are transverse to the vertical direction because such boxes are typically designed to efficiently stack the boxes after construction of the boxes yet before placement of food in the boxes. Such boxes for shoes typically have tops and bottoms with the tops defining dramatically smaller volumes than the bottoms because such boxes are typically designed so that both shoes in a pair fit entirely within the bottom volume. In both cases, the tops typically have larger footprints than the bottoms such that, when closed, the tops extend beyond the outer perimeter of the bottoms to make it easier for the user to grip a top and move it relative to a bottom. For at least these reasons, such boxes are inefficient with respect to storage of the boxes when closed and containing products.

### SUMMARY OF THE INVENTION

In a preferred version of the invention, a box has a total inner volume in a closed configuration. The box has a first box portion that defines a first inner volume and a second box portion that defines a second inner volume. The second box portion is preferably pivotally coupled to the first box portion along a clamshell hinge. The first and second inner volumes preferably combine to provide the total inner volume with each of the first and second inner volumes providing at least 30 percent of the total inner volume. The first box portion and the second box portion are preferably each formed from a unitary sheet of sheetstock material. The clamshell hinge is preferably a living hinge formed in the sheetstock material.

In some versions, the first box portion and the second box portion are formed in the unitary sheet. Preferably, the unitary sheet is a blank having a first blank portion that corresponds to the first box portion and a second blank portion that corresponds to the second box portion. The second blank portion is preferably integral to the first blank portion and pivotable relative to the first blank portion about the living clamshell hinge. The living clamshell hinge is preferably disposed along a border shared by the first and second blank portions. Each of the first and second blank portions preferably has a center panel, a first side panel integrally formed with the center panel along a first panel fold, a second side panel integrally formed with the center panel along a second panel fold disposed opposite the center panel from the first panel fold, a first locker flap integrally formed with the center panel along a first flap fold that extends from the first panel fold to the second panel fold, a second locker flap integrally formed with the center panel along a second flap fold disposed opposite the center panel from the first flap fold, a first blocker flap integrally formed with one of the first or second side panels along a third flap fold that is parallel to the first flap fold, and a second blocker flap integrally formed with one of the first or second side panels along a fourth flap fold that is parallel to the second flap fold. Each locker flap preferably has a blocker fold, a proximal portion that extends from a corresponding one of the first or second flap folds of a corresponding one of the first or second blank portions to the blocker fold, and a distal portion opposite the blocker fold from the proximal portion. The blocker fold is preferably offset from the corresponding flap fold by a first distance. Each blocker flap preferably corresponds to one of the first or second locker flaps of one of the first or second blank portions and has a blocker edge that is an edge of the blocker flap that is farthest offset from the corresponding locker flap, with the blocker edge being offset from the corresponding locker flap by a second distance along a dimension that is parallel to a corresponding one of the third or fourth flap folds of the corresponding blank portion. The second distance preferably matches the first distance of the corresponding locker flap.

Preferably, the first box portion has a first footprint. The second box portion preferably has a second footprint that matches the first footprint.

In some versions, the first box portion has a center panel and three or more sidewalls integrally formed with the center panel. The sidewalls are preferably oriented perpendicular to the center panel.

Preferably, the second box portion has a center panel and three or more sidewalls integrally formed with the center panel. The sidewalls are preferably oriented perpendicular to the center panel.

In some versions, the first box portion has a first rim that extends around the first box portion from a first end of the clamshell hinge to a second end of the clamshell hinge. The second box portion preferably has a second rim that extends around the second box portion from the first end of the clamshell hinge to the second end of the clamshell hinge. One or more portions of the first rim preferably abut one or more portions of the second rim without overlapping the one or more portions of the second rim in the closed configuration.

Preferably, the first box portion has one or more first clasp portions on one or more first sides of the first box portion. The second box portion preferably has one or more second clasp portions on one or more second sides of the second box portions. In the closed configuration, the first and second box portions preferably do not overlap each other except along the one or more first sides and the one or more second sides. One of the one or more first clasp portions is preferably a male clasp portion formed from the unitary sheet and integral to the first box portion. One of the one or more second clasp portions is preferably a female slot disposed in the second box portion.

In some versions, the first box portion has a first center panel and a first sidewall that is integrally formed with the first center panel along a first fold. The first sidewall preferably has a length that extends parallel to the first fold. The first sidewall preferably has a first clasp portion that is offset from a center of the length of the first sidewall and that is spaced apart from each edge of the first sidewall. The first clasp portion is preferably a male clasp portion formed from the unitary sheet and integral to the first box portion.

Preferably, the second box portion has a second center panel and a second sidewall that is integrally formed with the second center panel along a second fold. The second sidewall preferably has a length that extends parallel to the second fold. The second sidewall preferably has a second clasp portion that is offset from a center of the length of the second sidewall and that is spaced apart from each edge of the second sidewall. The first clasp portion is preferably a male clasp portion formed from the unitary sheet and integral to the first box portion. The second clasp portion is preferably a female slot disposed in the second box portion.

In some versions, the first clasp portion has a length that extends parallel to the first fold. The length of the first clasp portion preferably extends at least 30 percent of the length of the first sidewall.

Preferably, the second clasp portion has a length that extends parallel to the second fold. The length of the second clasp portion preferably extends at least 30 percent of the length of the second sidewall.

A preferred version of the invention includes a blank for constructing a box having a total inner volume in a closed configuration. The blank preferably includes a unitary sheet of sheetstock material. The unitary sheet preferably has a first blank portion and a second blank portion that is integral to the first blank portion and pivotable relative to the first blank portion about a living clamshell hinge disposed along a border shared by the first and second blank portion. Each of the first and second blank portions preferably has a center panel, a first side panel integrally formed with the center panel along a first panel fold, a second side panel integrally formed with the center panel along a second panel fold disposed opposite the center panel from the first panel fold, a first locker flap integrally formed with the center panel along a first flap fold that extends from the first panel fold to the second panel fold, a second locker flap integrally formed with the center panel along a second flap fold disposed opposite the center panel from the first flap fold, a first blocker flap integrally formed with one of the first or second side panels along a third flap fold that is parallel to the first flap fold, and a second blocker flap integrally formed with one of the first or second side panels along a fourth flap fold that is parallel to the second flap fold. Each locker flap preferably has a blocker fold, a proximal portion that extends from a corresponding one of the first or second flap folds of a corresponding one of the first or second blank portions to the blocker fold, and a distal portion opposite the blocker fold from the proximal portion. The blocker fold is preferably offset from the corresponding flap fold by a first distance. Each blocker flap preferably corresponds to one of the first or second locker flaps of one of the first or second blank portions and has a blocker edge that is an edge of the blocker flap that is farthest offset from the corresponding locker flap. The blocker edge is preferably offset from the corresponding locker flap by a second distance along a dimension that is parallel to a corresponding one of the third or fourth flap folds of the corresponding blank portion. The second distance preferably matches the first distance of the corresponding locker flap. The first and second blank portions are preferably sized and dimensioned to respectively form a first box portion and a second box portion that is pivotable relative to the first box portion about the living clamshell hinge. The first box portion preferably defines a first inner volume. The second box portion preferably defines a second inner volume. The first and second inner volumes preferably combine to provide the total inner volume with each of the first and second volumes providing at least 30 percent of the total inner volume.

In some version, the first side panel of a first one of the first or second blank portions is integrally formed with the first side panel of a second one of the first or second blank portions along the living clamshell hinge. The living clamshell hinge is preferably offset from the first panel fold of the first one of the first or second blank portions by a third distance. The living clamshell hinge is preferably offset from the first panel fold of the second one of the first or second blank portions by a fourth distance. The third distance preferably matches the first distance of the first one of the first or second blank portions. The fourth distance preferably matches the first distance of the second one of the first or second blank portions.

Preferably, the first and second panel folds are parallel to the living clamshell hinge. The first, second, third, and fourth flap folds are preferably perpendicular to the living clamshell hinge.

In some versions, each of the first and second blank portions has two locker tab slots. Each locker flap preferably has a locker tab that is positioned, sized, and dimensioned to be received in a corresponding one of the two locker tab slots of a corresponding one of the first or second blank portions.

Preferably, each locker flap has a finger hole. A diameter of the finger hole is preferably disposed along the blocker fold of the locker flap. Each blocker flap preferably has a quarter finger hole that intersects the blocker edge of the blocker flap.

A preferred version of the invention includes a method of making the box. The method preferably includes providing the blank. The first box portion is preferably constructed by pivoting various portions of the first blank portion. Each side panel of the first blank portion is preferably pivoted about a corresponding one of the of first or second panel folds of the first blank portion to orient the first and second side panels of the first blank portion perpendicular to the center panel of the first blank portion. Each blocker flap of the first blank portion is preferably pivoted about a corresponding one of the third or fourth flap folds to orient the first and second blocker flaps of the first blank portion perpendicular to a corresponding one of the first or second side panels of the first blank portion. The proximal portion of each locker flap of the first blank portion is preferably pivoted about a corresponding one of the first or second flap folds to orient the proximal portions of the first and second locker flaps of the first blank portion parallel to the first and second blocker flaps of the first blank portion. The proximal portion of each locker flap of the first blank portion is preferably pivoted about a corresponding one of the first or second blocker folds to position the distal portions of the first and second locker flaps of the first blank portion opposite a corresponding one of the first or second blocker flaps from the proximal portions of the first and second locker flaps of the first blank portion. The second box portion is preferably constructed by pivoting various portions of the second blank portion. Each side panel of the second blank portion is preferably pivoted about a corresponding one of the of first or second panel folds of the second blank portion to orient the first and second side panels of the second blank portion perpendicular to the center panel of the second blank portion. Each blocker flap of the second blank portion is preferably pivoted about a corresponding one of the third or fourth flap folds to orient the first and second blocker flaps of the second blank portion perpendicular to a corresponding one of the first or second side panels of the second blank portion. The proximal portion of each locker flap of the second blank portion is preferably pivoted about a corresponding one of the first or second flap folds to orient the proximal portions of the first and second locker flaps of the second blank portion parallel to the first and second blocker flaps of the second blank portion. The proximal portion of each locker flap of the second blank portion is preferably pivoted about a corresponding one of the first or second blocker folds to position the distal portions of the first and second locker flaps of the second blank portion opposite a corresponding one of the first or second blocker flaps from the proximal portions of the first and second locker flaps of the second blank portion.

### BRIEF DESCRIPTION OF THE DRAWINGS

Preferred and alternative examples of the present invention are described in detail below with reference to the following drawings:

FIG. 1 is a plan view of a preferred clamshell box blank.

FIG. 2 is a perspective view of a preferred clamshell box in an open configuration.

FIG. 3 is a perspective view of a preferred clamshell box in an open configuration.

FIG. 4 is a perspective view of a preferred clamshell box transitioning between an open configuration and a closed configuration.

FIG. 5 is a perspective view of a preferred clamshell box in a closed configuration.

FIG. 6 is a plan view of a preferred clamshell box blank.

FIG. 7 is a perspective view of a preferred clamshell box in an open configuration.

FIG. 8 is a perspective view of a preferred clamshell box in an open configuration.

FIG. 9 is a perspective view of a preferred clamshell box in a closed configuration.

FIG. 10 is a perspective view of a preferred clamshell box in an open configuration.

FIG. 11 is a perspective view of a preferred clamshell box in an open configuration.

FIG. 12 is a perspective view of a preferred clamshell box transitioning between an open configuration and a closed configuration.

FIG. 13 is a perspective view of a preferred clamshell box in a closed configuration.

### DETAILED DESCRIPTION OF THE PREFERRED EMBODIMENT

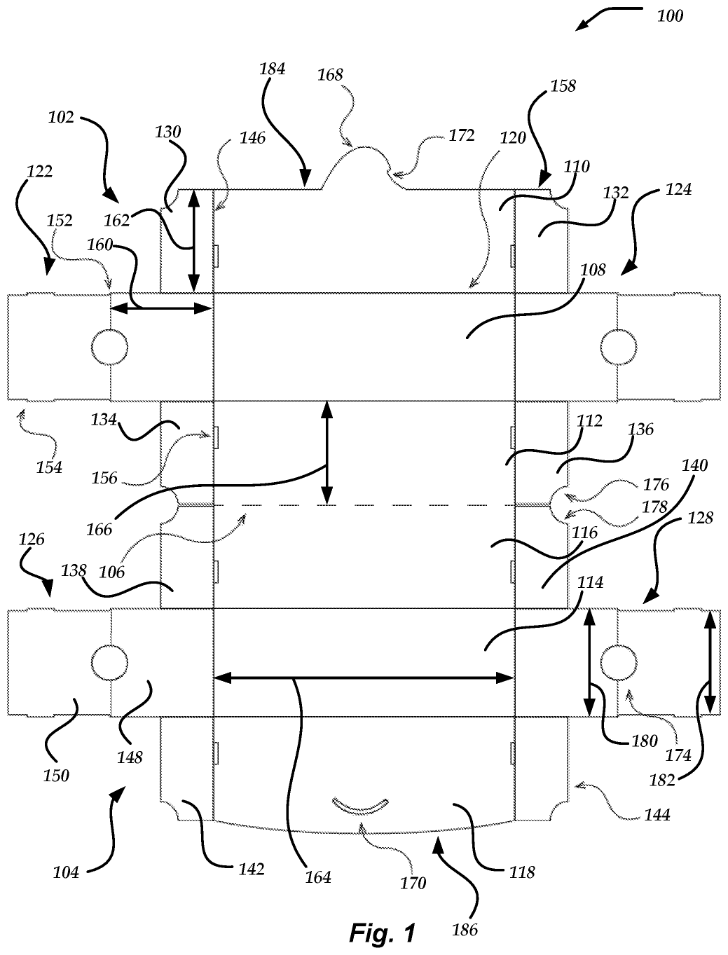

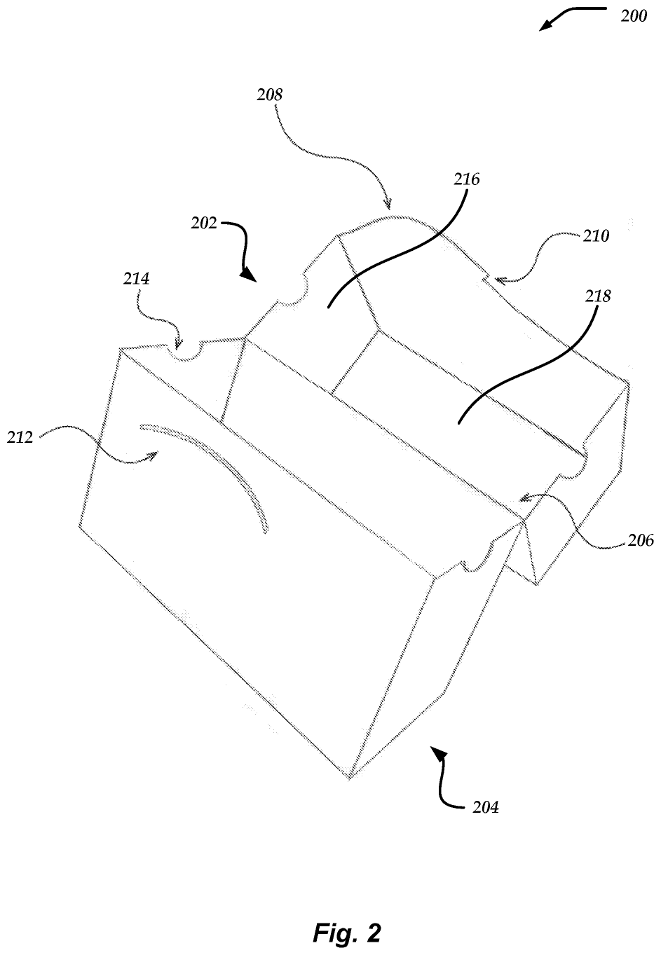

A preferred clamshell box blank 100 is illustrated in FIG. 1 and may be used to construct a clamshell box, such as the clamshell boxes shown in FIGS. 2, 4, and 5. Preferably, the blank 100 is a unitary sheet of sheetstock material that includes a first blank portion 102 and a second blank portion 104 that is connected to the first blank portion 102 along a living clamshell hinge 106. The first and second blank portions 102, 104 each include multiple panels that are preferably defined by three or more folds. The first blank portion 102 preferably has a center panel 108 and two side panels 110, 112 that border opposite edges of the center panel 108, and the second blank portion 104 preferably has a center panel 114 and two side panels 116, 118 that border opposite edges of the center panel 114. The panels 108-118 are each coupled to at least one other panel along at least one panel fold, such as panel fold 120.

Each panel 108-118 preferably has two flaps, with each of the center panels 108, 114 typically having two locker flaps 122-128 and each of the side panels typically having one or more blocker flaps 130-144. The flaps 122-144 can preferably move independently of each other and typically border an edge of a corresponding one of the panels 108-118 along a flap fold, such as flap fold 146. The locker flaps 122-128 preferably each have a proximal portion (for example, a proximal portion 148 of the locker flap 126) and a distal portion (for example, a distal portion 150 of the locker flap 126) opposite a blocker fold (for example, blocker fold 152) from the proximal portion. The locker flaps 122-128 typically have one or more tabs (for example, tab 154 in locker flap 122) that are positioned, sized, and dimensioned to be received in one or more slots disposed in one or more portions of the blank 100 (for example, one or more of the panels 108-118 or the flaps 122-144), such as a slot 156 in the side panel 112.

To construct a clamshell box from the blank 100 (see, for example, FIGS. 2, 4, and 5), the side panels 110, 112, 116, 118 are preferably pivoted about the panel folds between those side panels and their corresponding center panels 108, 110 to orient the side panels 110, 112, 116, 118 perpendicular to their corresponding center panels 108, 110. The blocker flaps 130-144 are preferably pivoted about their corresponding flap folds to orient the blocker flaps 130-144 perpendicular to their corresponding side panels 110, 112, 116, 118. The locker flaps 122-128 are preferably pivoted about their corresponding flap folds to orient at least the proximal portions of the locker flaps 122-128 perpendicular to their corresponding center panels 108, 110. The distal portions of the locker flaps 122-128 are preferably pivoted about their corresponding blocker folds to orient the distal portions of the locker flaps 122-128 perpendicular to their corresponding center panels 108, 110. The tabs of the locker flaps 122-128 are inserted into the corresponding slots.

The blocker flaps 130-144 preferably each have a blocker edge (for example, a blocker edge 158 of the blocker flap 132) that is typically the edge of the blocker flap that is farthest offset along the dimension perpendicular to the clamshell hinge 106 from the panel fold that borders the side panel of the blocker flap and the corresponding center panel. For example, the blocker flap 132 has a blocker edge 158 that is farthest offset along the dimension perpendicular to the clamshell hinge 106 from the panel fold 120 that borders the side panel 110 of the blocker flap 132 and the corresponding center panel 108. The blocker fold of each locker flap is preferably offset from the corresponding center panel by a distance (for example, a distance 160 typically measured parallel to the clamshell hinge 106) that equals or substantially equals (for example, within 5, 10, 15, or 20 percent) the distance by which the blocker edge of the nearest one or more blocker flaps is offset from the panel fold that borders the side panel of the blocker flap and the corresponding center flap (for example, a distance 162 measured perpendicular to the clamshell hinge 106). After the blank 100 is constructed into a clamshell box (see, for example, FIGS. 2, 4, and 5), this arrangement facilitates one or more of the blocker edges and one of the blocker folds cooperatively blocking the path that one or more of the blocker flaps travels when a force attempts to pivot the corresponding one or more side panels and center panel relative to each other about the corresponding one or more panel folds while the locker flap tabs are in the corresponding slots thereby locking the blank 100 into the constructed configuration of the clamshell box without adhesive (see, for example, FIGS. 2, 4, and 5). Optionally, however, adhesive may be used to reinforce the locking of the constructed configuration.

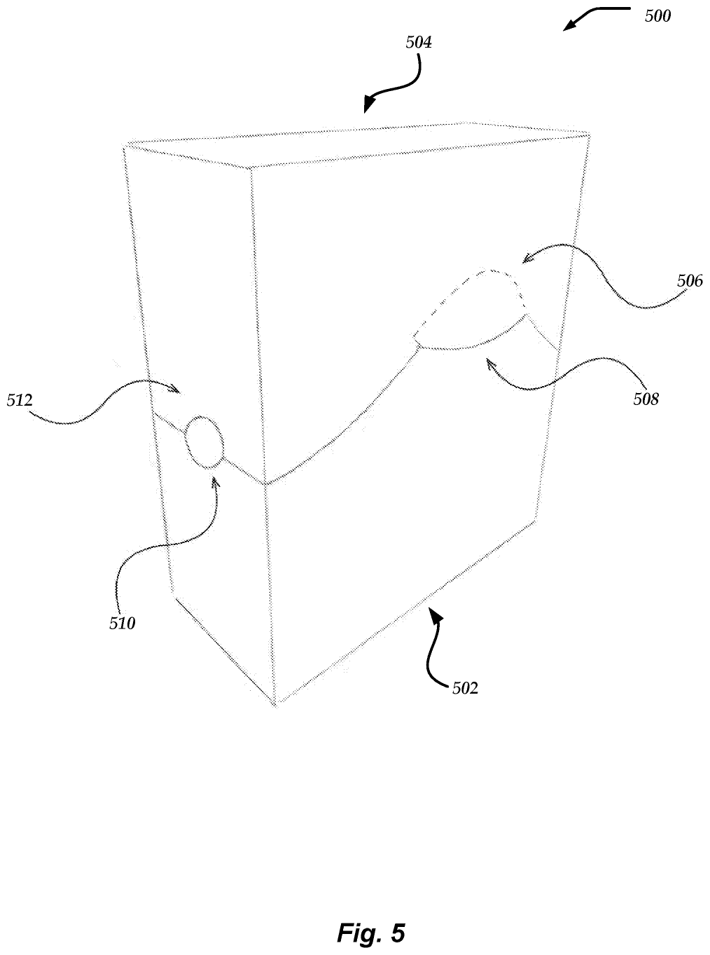

The panels of the first blank portion 102 typically have the same lengths when measured parallel to the clamshell hinge 106 (for example, a length 164 of the center panel 114) as the corresponding panels of the second blank portion 104, and, most preferably, all of the panels have the same lengths. The side panels 112, 116 between the center panels 108, 114 preferably have heights when measured perpendicular to the clamshell hinge 106 (for example, a height 166 of the side panel 112) that differ from each other by no more than 50, 40, 30, 20, or 10 percent of the larger of those two side panels 112, 116, and, most preferably, the side panels 112, 116 have the same heights. The blocker fold of one or more of the locker flaps 122-128 (preferably two or more of the locker flaps, more preferably three or more of the locker flaps, and most preferably all the locker flaps) is typically offset from the corresponding center panel 108, 114 by a distance (for example, the distance 160) that equals the height of the side panel 112, 116 in the same portion 102, 104 as the one or more of the locker flaps 122-128. Preferably, when the clamshell box is in a closed configuration (see, for example, FIG. 5), one or both of the blocker folds of the locker flaps 122, 124 respectively forms a rim of the clamshell box that abuts a rim of the clamshell box respectively formed by one or both of the blocker folds of the corresponding locker flaps 126, 128.

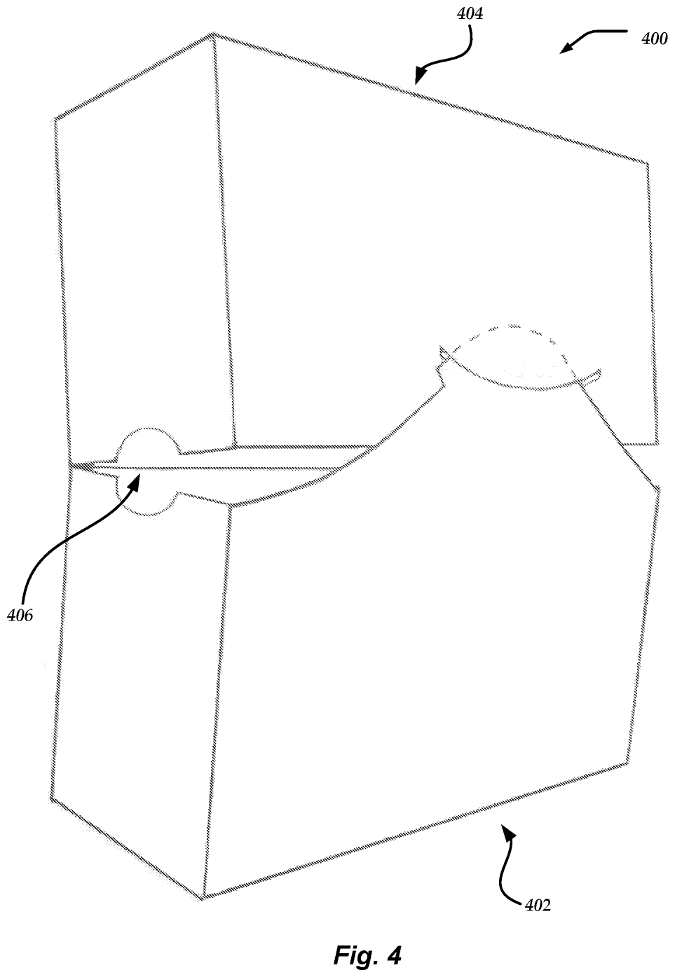

One or both of the side panels 110, 118 preferably has one or more male portions of one or more clasps (for example, a male clasp portion 168), and the other or both of the side panels 110, 118 preferably has one or more corresponding female portions of the one or more clasps (for example, a female clasp portion 170) to facilitate fastening the first blank portion 102 and the second blank portion 104 together when the clamshell box is in the closed configuration (see, for example, FIGS. 4 and 5). Preferably, one or more male clasp portions has one or more catches (for example, a catch 172 of the male clasp portion 168) to further facilitate maintaining the closed configuration. As shown in the figures, the male clasp portion extends through the female clasp portion from an exterior of the box, yet the male clasp portion may alternatively extend through the female clasp portion from an interior of the box, thereby facilitating displaying the male clasp portion in the closed configuration and thus displaying any ornamental shaping of the male clasp portion or imagery or text disposed on the male clasp portion.

The blank 100 typically includes one or more grips that facilitate a user opening the clamshell box. The one or more grips typically include one or more finger holes that facilitate the user placing one or more of her fingers through the one or more finger holes to open the clamshell box. A finger hole (for example, a finger hole 174) is preferably disposed in each locker flap 122-128 with a diameter of the finger hole disposed along the blocker fold of the corresponding locker flap 122-128. Accordingly, when the clamshell box is in the closed configuration (see, for example, FIG. 5), the finger hole in each locker flap 122-128 typically forms a half finger hole that combines with a half finger hole of another locker flap 122-128 to form a full finger hole as shown in FIG. 5. In versions in which one or more portions of one or more of the blocker flaps 130-144 overlap one or more portions of one or more finger holes in the locker flaps 122-128, one or more corresponding finger-hole portions are preferably disposed in the one or more portions of the one or more of the blocker flaps 130-144. In the version shown in FIG. 1, a quarter finger hole is disposed in the distal edge of each blocker fold at the corner opposite the corresponding locker flap 122-128. For example, the blocker flap 136 has a quarter finger hole 176 disposed in its distal edge at the corner opposite the locker flap 124, and the blocker flap 140 has a quarter finger hole 178 disposed in its distal edge at the corner opposite the blocker flap 128.

The proximal portion of one or more of the locker flaps 122-128 has a width measured perpendicular to the clamshell hinge 106 (for example, a width 180 of the proximal portion of the locker flap 128) that is preferably greater than a width of the distal portion of the same one or more of the locker flaps 122-128 (for example, a width 182 of the distal portion of the locker flap 128) to facilitate the proximal portion entirely covering one or more of the blocker flaps 130-144 as viewed from the exterior of the constructed clamshell box without the distal portion pressing one or more of the side panels 110, 112, 116, 118 outward beyond the width of the proximal portion (see, for example, FIGS. 2 and 5).

The side panels 110, 118 each have respective free edges 184, 186 that form rims of the clamshell box. In the version shown in FIG. 1, the edge 186 of the side panel 118 is sized and dimensioned to at least partially overlap the edge 184 of the side panel 110 when the clamshell box is in the closed configuration (see, for example, FIGS. 4 and 5). In other versions, the edges 184, 186 are sized and dimensioned to abut each other without overlapping each other when the clamshell box is in the closed configuration. In the version shown in FIG. 1, the male and female clasp portions 168, 170 are centered along the lengths of the side panels 110, 118. In other versions, the male and female clasp portions 168, 170 are offset from the midpoint of the lengths of the side panels 110, 118 (see, for example, FIGS. 2-5).

A constructed clamshell box 200 in an open configuration is shown in FIG. 2 and may be constructed from a blank similar to the blank 100. The clamshell box 200 has a first box portion 202 and a second box portion 204 that respectively correspond to the first and second blank portions 102, 104 of the blank 100. The first and second box portions 202, 204 are pivotally coupled to each other along a living clamshell hinge 206. The first box portion 202 has a male clasp portion 208 with a catch 210, and the second box portion 204 has a female clasp portion 212. The short sides of the clamshell box 200 each include a half finger hole (for example, a half finger hole 214) that, when the clamshell box 200 is in the closed configuration (see, for example, FIG. 5), aligns with another half finger hole to form a whole finger hole. The distal portions of the locker flaps of the clamshell box 200 (for example, a distal locker flap portion 216) are sized and dimensioned to extend entirely to the center panels to which the proximal portions of the locker flaps are coupled (for example, a center panel 218).

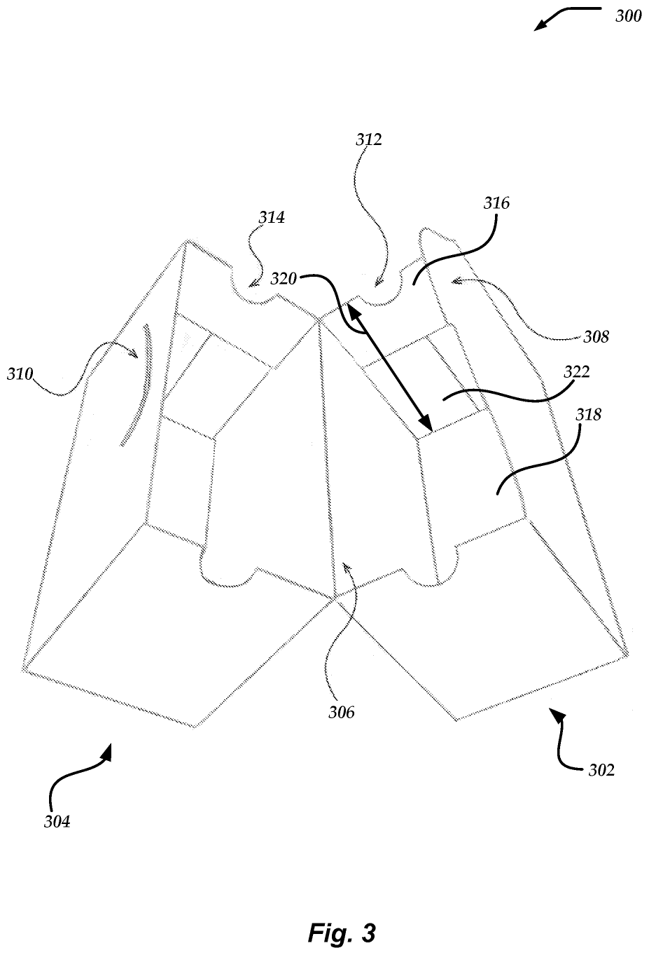

A constructed clamshell box 300 in an open configuration is shown in FIG. 3 and may be constructed from a blank similar to the blank 100. The clamshell box 300 has a first box portion 302 and a second box portion 304 that respectively correspond to the first and second blank portions 102, 104 of the blank 100. The first and second box portions 302, 304 are pivotally coupled to each other along a living clamshell hinge 306. The first box portion 302 has a male clasp portion 308 with a catch, and the second box portion 304 has a female clasp portion 310. The short sides of the clamshell box 300 each include a half finger hole (for example, half finger holes 312, 314) that, when the clamshell box 300 is in the closed configuration (see, for example, FIG. 5), aligns with another half finger hole to form a whole finger hole. The distal portions of the locker flaps of the clamshell box 300 (for example, a distal locker flap portion 316) are sized and dimensioned to extend only partially toward the center panels to which the proximal portions of the locker flaps are coupled (for example, a center panel 318).

Relative to the clamshell box 200 of FIG. 2, the clamshell box 300 uses less material to construct the clamshell box 300 and its corresponding blank due to the shorter locker flaps. The clamshell box 200, however, facilitates providing a stronger locking mechanism because the tabs in the proximal portions of the locker flaps can be disposed farther from the blocker folds, thereby increasing the effectiveness of the tabs due to the increased lengths of the levers. The clamshell box 200 also facilitates reducing the likelihood that the blocker flaps are snagged by product inside the clamshell box 200, thereby protecting the blocker flaps and the product. This same effect can be achieved in the clamshell box 200 by reducing the height of the locker flaps as measured perpendicular to the clamshell hinge 306 (for example, a height 320 of a blocker flap 322) to be no greater than the height of the distal portion of the corresponding locker flap as measured along the same dimension, with the blocker edges of the blocker flaps abutting the blocker folds of the locker flaps.

A constructed clamshell box 400 transitioning between an open configuration (see, for example, FIGS. 2 and 3) and a closed configuration (see, for example, FIG. 5) is shown in FIG. 4 and may be constructed from a blank similar to the blank 100. The clamshell box 400 has a first box portion 402 and a second box portion 404 that respectively correspond to the first and second blank portions 102, 104 of the blank 100. The first and second box portions 402, 404 are pivotally coupled to each other along a living clamshell hinge 406.

A constructed clamshell box 500 in a closed configuration is shown in FIG. 5 and may be constructed from a blank similar to the blank 100. The clamshell box 500 has a first box portion 502 and a second box portion 504 that respectively correspond to the first and second blank portions 102, 104 of the blank 100. The first and second box portions 502, 504 are pivotally coupled to each other along a clamshell hinge (see, for example, FIGS. 1-4). The first box portion 502 has a male clasp portion 506 with a catch (shown in hidden lines), and the second box portion 504 has a female clasp portion 508. The short sides of the clamshell box 500 each include a half finger hole (for example, half finger holes 510, 512) that, in the closed configuration, align with another half finger hole to form a whole finger hole. This arrangement facilitates visual inspection of the contents of the box 500, such as shoes, small accessories, or other objects. Each of the blocker folds of the locker flaps forms a rim of the first or second box portions 502, 504 that abut a corresponding rim of the other of the first and second box portions 502, 504. Accordingly, the first and second box portions 502, 504 mate around the edges of the rim of each of the first and second box portions 502, 504 in the closed configuration without either of the first and second box portions 502, 504 overlapping the other, except in a region of overlap that corresponds to the male and female clasp portions 506, 508.

Because the first and second box portions 502, 504 have the same footprints as each other, the clamshell box 500 is highly efficient when storing many of the clamshell box 500 in the closed configuration. Because the first and second box portions 502, 504 have substantially the same inner volumes, approximately the same amount of product can be stored in each of the first and second box portions 502, 504 and can separately accessible when the clamshell box 500 is in the open configuration (see, for example, FIGS. 2 and 3). In the case of a pair of shoes being contained in the clamshell box 500, one shoe can be stored in each of the first and second box portions 502, 504 and therefore can be oriented with the topline (portion of the shoe through which a wearer inserts her foot) fully exposed and accessible when the clamshell box 500 is in the open configuration. Also in the case of a pair of shoes, the toplines of the shoes can be disposed at the same end portion of the box 500, thereby facilitating a user removing both shoes for wearing without rotating one of the shoes 180° to bring the toplines into alignment.

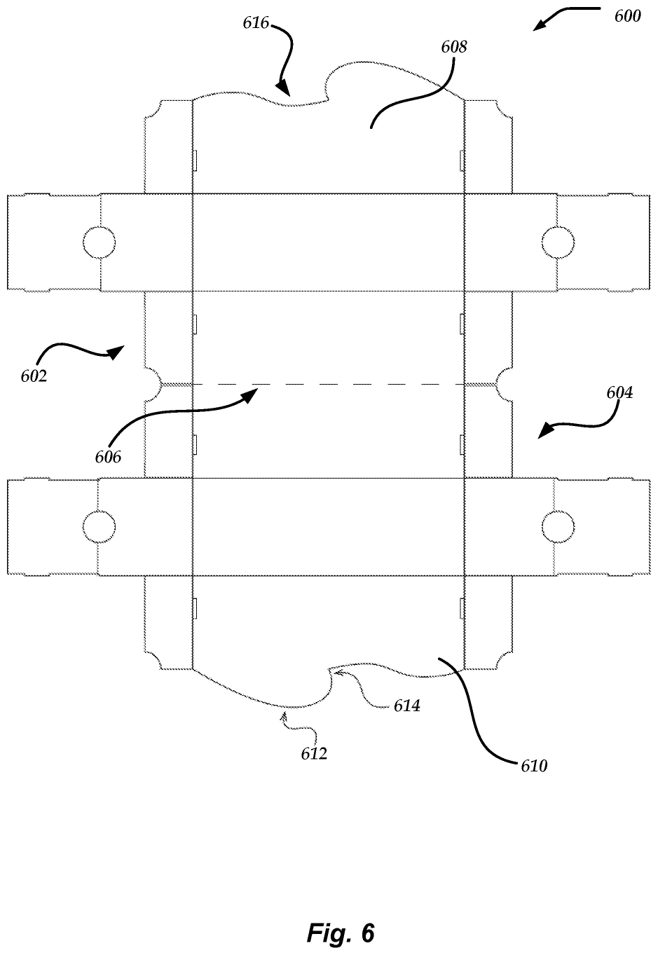

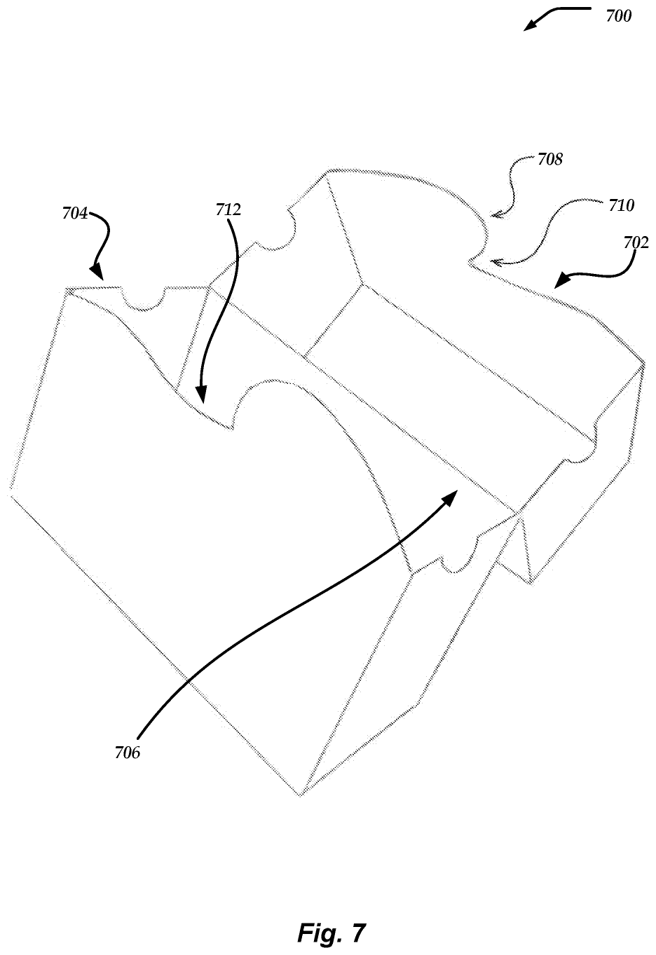

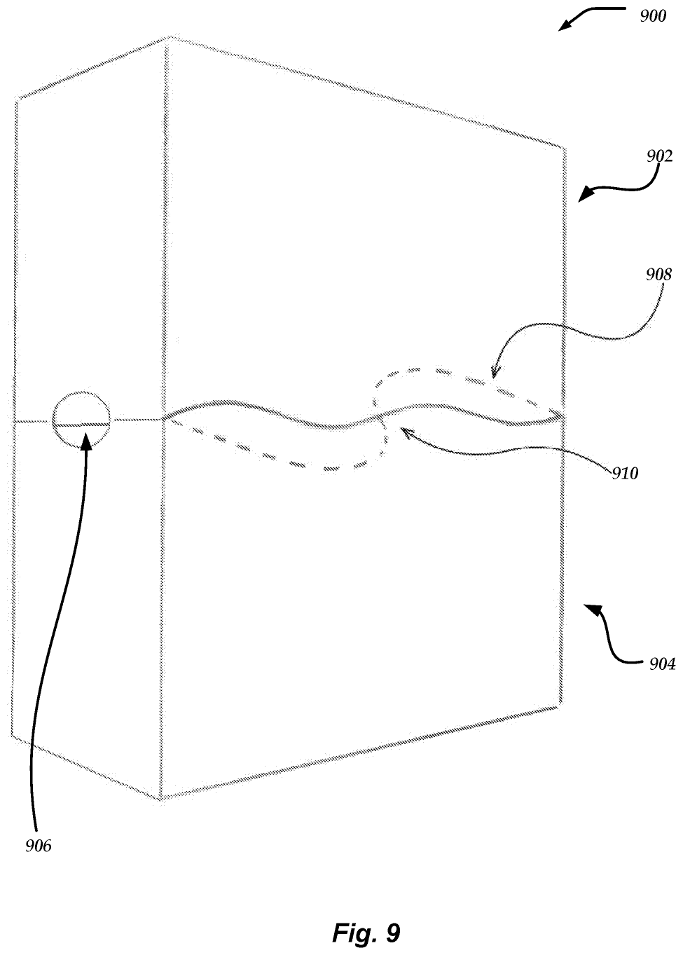

A preferred clamshell box blank 600 is illustrated in FIG. 6 and may be used to construct a clamshell box, such as the clamshell boxes shown in FIGS. 7 and 9. Preferably, the blank 600 is a unitary sheet of sheetstock material that includes a first blank portion 602 and a second blank portion 604 that is connected to the first blank portion 602 along a living clamshell hinge 606. The first and second blank portions 602, 604 are substantially the same as the first and second blank portions 102, 104 of the blank 100, except for the clasp mechanisms. The blank 600 preferably has a male clasp portion with a catch in each of two side panels 608, 610 (for example, a male clasp portion 612 with a catch 614) and a female clasp portion in each of the side panels 608, 610 (for example, a female clasp portion 616).

A constructed clamshell box 700 in an open configuration is shown in FIG. 7 and may be constructed from a blank similar to the blank 600. The clamshell box 700 has a first box portion 702 and a second box portion 704 that respectively correspond to the first and second blank portions 602, 604 of the blank 600. The first and second box portions 702, 704 are pivotally coupled to each other along a living clamshell hinge 706. Each of the first and second box portions 702, 704 has a male clasp portion with a catch (for example, a male clasp portion 708 with a catch 710) a female clasp portion (for example, a female clasp portion 712).

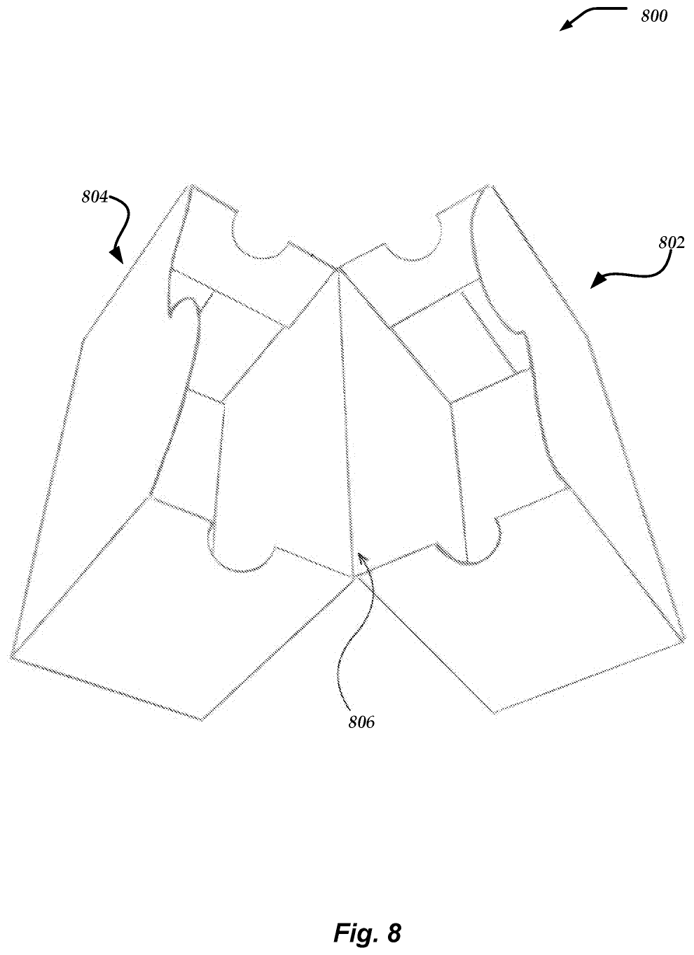

A constructed clamshell box 800 in an open configuration is shown in FIG. 8 and may be constructed from a blank similar to the blank 600. The clamshell box 800 has a first box portion 802 and a second box portion 804 that respectively correspond to the first and second blank portions 602, 604 of the blank 600. The first and second box portions 802, 804 are pivotally coupled to each other along a living clamshell hinge 806. Each of the first and second box portions 802, 804 has a male clasp portion with a catch and a female clasp portion. The distal portions of the locker flaps of the clamshell box 800 are sized and dimensioned to extend only partially toward the center panels to which the proximal portions of the locker flaps are coupled, as discussed regarding the clamshell box 300 of FIG. 3.

A constructed clamshell box 900 in a closed configuration is shown in FIG. 9 and may be constructed from a blank similar to the blank 600. The clamshell box 900 has a first box portion 902 and a second box portion 904 that respectively correspond to the first and second blank portions 602, 604 of the blank 600. The first and second box portions 902, 904 are pivotally coupled to each other along a living clamshell hinge 906. Each of the first and second box portions 902, 904 has a male clasp portion with a catch (shown in hidden lines) (for example, a male clasp portion 908) and a female clasp portion (for example, a female clasp portion 910. Each of the blocker folds of the locker flaps forms a rim of the first or second box portions 902, 904 that abut a corresponding rim of the other of the first and second box portions 902, 904. Accordingly, the first and second box portions 902, 904 mate around the edges of the rim of each of the first and second box portions 902, 904 in the closed configuration without either of the first and second box portions 902, 904 overlapping the other, except in a region of overlap that corresponds to the male and female clasp portions.

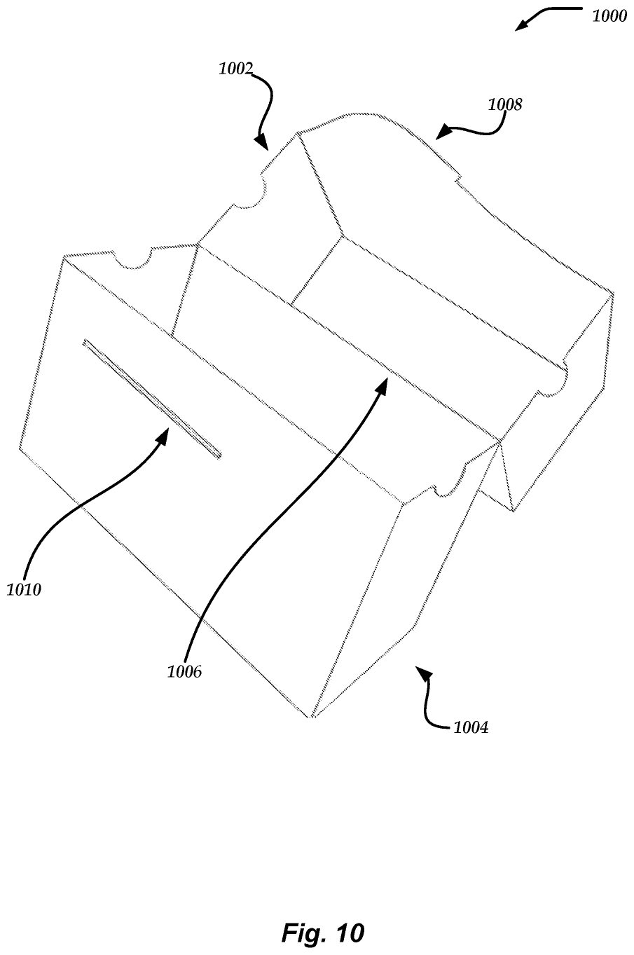

A constructed clamshell box 1000 in an open configuration is shown in FIG. 10 and may be constructed from a blank similar to the blank 100. The clamshell box 1000 has a first box portion 1002 and a second box portion 1004 that respectively correspond to the first and second blank portions 102, 104 of the blank 100. The first and second box portions 1002, 1004 are pivotally coupled to each other along a living clamshell hinge 1006. The first box portion 1002 has a male clasp portion 1008 with a catch, and the second box portion 1004 has a female clasp portion 1010. Contrasting the clamshell box 200 in FIG. 2 with the clamshell box 1000 in FIG. 10, the main difference is the shape of the female clasp portions 212, 1010. The curved female clasp portion 212 facilitates easier insertion of the male clasp portion 208, and the straight female clasp portion 1010 facilitates easier manufacturing.

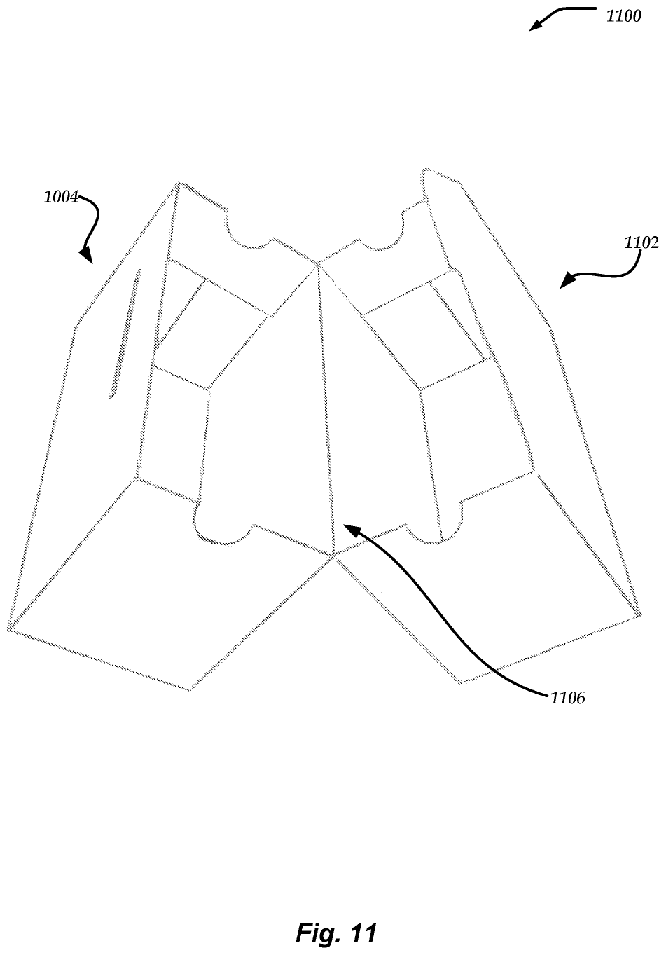

A constructed clamshell box 1100 in an open configuration is shown in FIG. 11 and may be constructed from a blank similar to the blank 100. The clamshell box 1100 has a first box portion 1102 and a second box portion 1104 that respectively correspond to the first and second blank portions 102, 104 of the blank 100. The first and second box portions 1102, 1104 are pivotally coupled to each other along a living clamshell hinge 1106. The first box portion 1102 has a male clasp portion with a catch, and the second box portion 1104 has a straight female clasp portion. The distal portions of the locker flaps of the clamshell box 1100 are sized and dimensioned to extend only partially toward the center panels to which the proximal portions of the locker flaps are coupled, as discussed regarding the clamshell box 300 of FIG. 3.

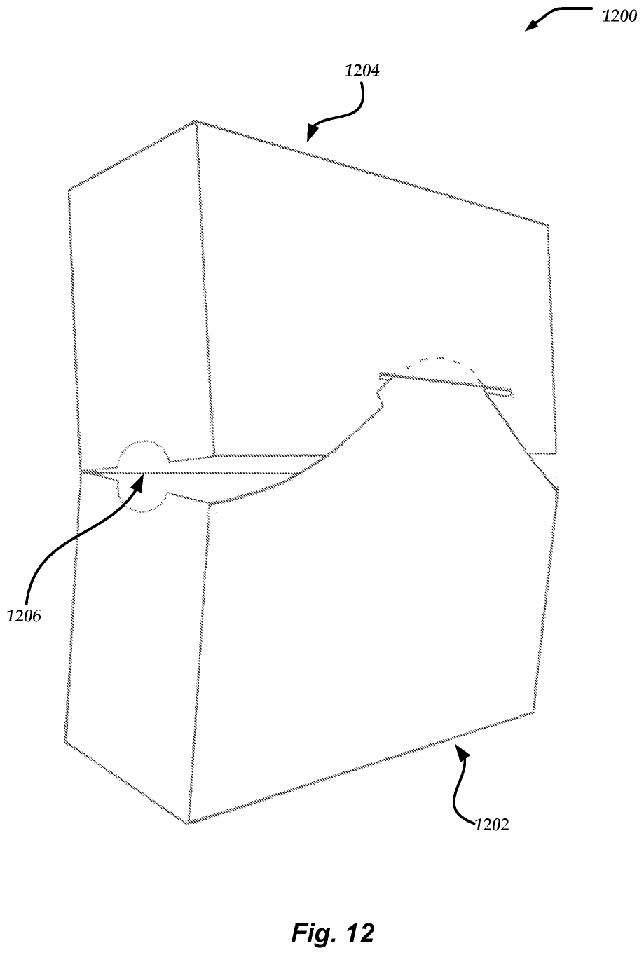

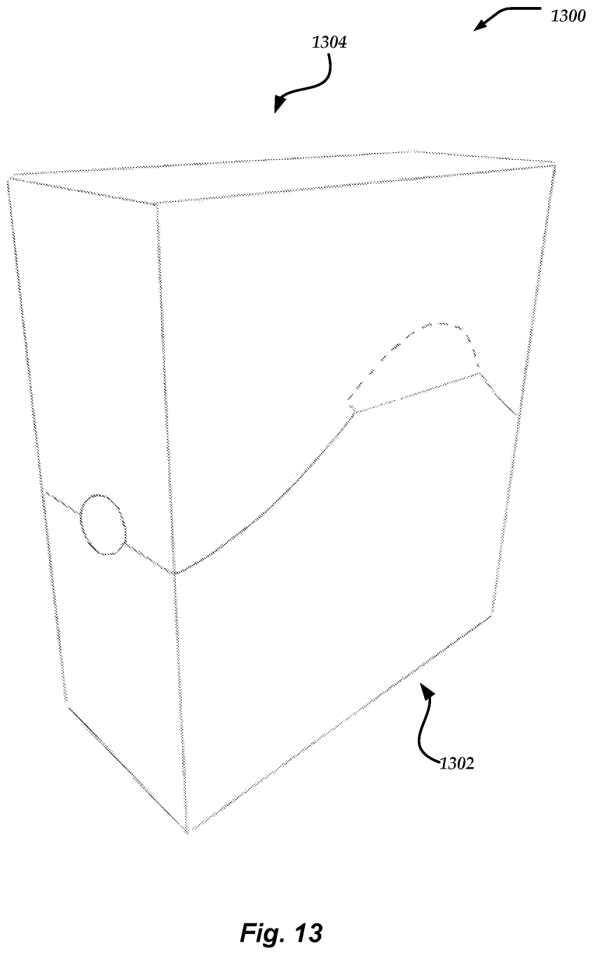

A constructed clamshell box 1200 transitioning between an open configuration (see, for example, FIGS. 10 and 11) and a closed configuration (see, for example, FIG. 13) is shown in FIG. 12 and may be constructed from a blank similar to the blank 100. The clamshell box 1200 has a first box portion 1202 and a second box portion 1204 that respectively correspond to the first and second blank portions 102, 104 of the blank 100. The first and second box portions 1202, 1204 are pivotally coupled to each other along a living clamshell hinge 1206. The first box portion 1202 has a male clasp portion with a catch, and the second box portion 1204 has a straight female clasp portion.

A constructed clamshell box 1300 in a closed configuration is shown in FIG. 13 and may be constructed from a blank similar to the blank 100. The clamshell box 1300 has a first box portion 1302 and a second box portion 1304 that respectively correspond to the first and second blank portions 102, 104 of the blank 100. The first and second box portions 1302, 1304 are pivotally coupled to each other along a clamshell hinge (see, for example, FIGS. 10-12). The first box portion 1302 has a male clasp portion with a catch (shown in hidden lines), and the second box portion 1304 has a straight female clasp portion. Each of the blocker folds of the locker flaps forms a rim of the first or second box portions 1302, 1304 that abut a corresponding rim of the other of the first and second box portions 1302, 1304. Accordingly, the first and second box portions 1302, 1304 mate around the edges of the rim of each of the first and second box portions 1302, 1304 in the closed configuration without either of the first and second box portions 1302, 1304 overlapping the other, except in a region of overlap that corresponds to the male and female clasp portions.

In the closed configuration, one of the first and second box portions of the clamshell boxes typically forms a top box portion with the corresponding center panel forming a top of the clamshell box, and the other of the first and second box portions typically forms a bottom box portion with the corresponding center panel forming a bottom of the clamshell box. In the versions shown in the figures, the clamshell boxes have rectangular footprints with two side panels, two locker flaps, and one center panel in each of the top and bottom box portions of the clamshell box. Other versions have footprints of different shapes (for example, triangular, pentagonal, octagonal, or other shapes) with a corresponding number of side panels, a corresponding number of locker flaps, and typically one center panel in each of the top and bottom box portions of the clamshell box. The clamshell boxes and their corresponding blanks are typically constructed with sheetstock material, such as paperboard or cardboard yet may include other materials, such as plastics. The versions shown in the figures provide clamshell boxes having equal volumes in the top portions and the bottom portions. In other versions, the top and bottom portions have different volumes, such as the top box portion or the bottom box portion having 30-40, 40-50, or 30-50 percent of the total inner volume of the clamshell box. The constructed clamshell boxes typically have their side panels, locker flaps, and blocker flaps oriented perpendicular to the corresponding center panels to facilitate efficient storage in the closed configuration. Each male and female clasp portion has a length as measured parallel to panel fold that couples the corresponding side panel to the corresponding center panel, and the length preferably extends along 20, 30, 40, or more percent of the length of the corresponding side panel to facilitate a user easily transitioning the clamshell box between the open and closed configurations. In the versions shown in the figures, the constructed clamshell boxes have sidewalls that are defined by the side panels and the locker flaps extending perpendicular to the corresponding center panels, which define bottoms and tops of their respective first and second box portions (such as first and second box portions 202, 204).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow

The embodiments of the invention in which an exclusive property or privilege is claimed are defined as follows:

1. A box having a total inner volume in a closed configuration, the box comprising:
a first box portion that defines a first inner volume;
a second box portion that defines a second inner volume, the second box portion being pivotally coupled to the first box portion along a clamshell hinge, and the first and second inner volumes combining to provide the total inner volume with each of the first and second inner volumes providing at least 30 percent of the total inner volume; and
wherein the first box portion and the second box portion are each formed from a unitary sheet of sheetstock material, and further wherein the clamshell hinge is a living hinge formed in the sheetstock material.

2. The box of claim 1, wherein the first box portion and the second box portion are formed in the unitary sheet, the unitary sheet being a blank having:
a first blank portion that corresponds to the first box portion; and
a second blank portion that corresponds to the second box portion, the second blank portion being integral to the first blank portion and pivotable relative to the first blank portion about the living clamshell hinge, the living clamshell hinge being disposed along a border shared by the first and second blank portions,
wherein each of the first and second blank portions has a center panel, a first side panel integrally formed with the center panel along a first panel fold, a second side panel integrally formed with the center panel along a second panel fold disposed opposite the center panel from the first panel fold, a first locker flap integrally formed with the center panel along a first flap fold that extends from the first panel fold to the second panel fold, a second locker flap integrally formed with the center panel along a second flap fold disposed opposite the center panel from the first flap fold, a first blocker flap integrally formed with one of the first or second side panels along a third flap fold that is parallel to the first flap fold, and a second blocker flap integrally formed with one of the first or second side panels along a fourth flap fold that is parallel to the second flap fold,
wherein each locker flap has a blocker fold, a proximal portion that extends from a corresponding one of the first or second flap folds of a corresponding one of the first or second blank portions to the blocker fold, and a distal portion opposite the blocker fold from the proximal portion, the blocker fold being offset from the corresponding flap fold by a first distance, and
wherein each blocker flap corresponds to one of the first or second locker flaps of one of the first or second blank portions and has a blocker edge that is an edge of the blocker flap that is farthest offset from the corresponding locker flap, the blocker edge being offset from the corresponding locker flap by a second distance along a dimension that is parallel to a corresponding one of the third or fourth flap folds of the corresponding blank portion, the second distance matching the first distance of the corresponding locker flap.

3. The box of claim 1, wherein the first box portion has a first footprint, and the second box portion has a second footprint that matches the first footprint.

4. The box of claim 1, wherein the first box portion has a center panel and three or more sidewalls integrally formed with the center panel, the sidewalls being oriented perpendicular to the center panel.

5. The box of claim 1, wherein the first box portion has a first center panel and three or more first sidewalls integrally formed with the first center panel, and the second box portion has a second center panel and three or more second sidewalls integrally formed with the second center panel, the first sidewalls being oriented perpendicular to the first center panel, and the second sidewalls being oriented perpendicular to the second center panel.

6. The box of claim 1, wherein the first box portion has a first rim that extends around the first box portion from a first end of the clamshell hinge to a second end of the clamshell hinge, and the second box portion has a second rim that extends around the second box portion from the first end of the clamshell hinge to the second end of the clamshell hinge, and one or more portions of the first rim abut one or more portions of the second rim without overlapping the one or more portions of the second rim in the closed configuration.

7. The box of claim 1, wherein the first box portion has one or more first clasp portions on one or more first sides of the first box portion, the second box portion has one or more second clasp portions on one or more second sides of the second box portions, and, in the closed configuration, the first and second box portions do not overlap each other except along the one or more first sides and the one or more second sides, one of the one or more first clasp portions being a male clasp portion formed from the unitary sheet and integral to the first box portion, and one of the one or more second clasp portions being a female slot disposed in the second box portion.

8. The box of claim 1, wherein the first box portion has a first center panel and a first sidewall that is integrally formed with the first center panel along a first fold, the first sidewall has a length that extends parallel to the first fold, and the first sidewall has a first clasp portion that is offset from a center of the length of the first sidewall and that is spaced apart from each edge of the first sidewall, the first clasp portion being a male clasp portion formed from the unitary sheet and integral to the first box portion.

9. The box of claim 1, wherein the first box portion has a first center panel and a first sidewall that is integrally formed with the first center panel along a first fold, the first sidewall has a length that extends parallel to the first fold, the first sidewall has a first clasp portion that is offset from a center of the length of the first sidewall and that is spaced apart from each edge of the first sidewall, the second box portion has a second center panel and a second sidewall that is integrally formed with the second center panel along a second fold, the second sidewall has a length that extends parallel to the second fold, and the second sidewall has a second clasp portion that is offset from a center of the length of the second sidewall and that is spaced apart from each edge of the second sidewall, the first clasp portion being a male clasp portion formed from the unitary sheet and integral to the first box portion, and the second clasp portion being a female slot disposed in the second box portion.

10. The box of claim 1, the first box portion has a first center panel and a first sidewall that is integrally formed with the first center panel along a first fold, the first sidewall has a length that extends parallel to the first fold, the first sidewall has a first clasp portion that has a length that extends parallel to the first fold, and the length of the first clasp portion extends at least 30 percent of the length of the first sidewall, the first clasp portion being a male clasp portion formed from the unitary sheet and integral to the first box portion.

11. The box of claim 1, wherein the first box portion has a first center panel and a first sidewall that is coupled to the first center panel along a first fold, the first sidewall has a length that extends parallel to the first fold, the first sidewall has a first clasp portion that has a length that extends parallel to the first fold, the length of the first clasp portion extends at least 30 percent of the length of the first sidewall, the second box portion has a second center panel and a second sidewall that is coupled to the second center panel along a second fold, the second sidewall has a length that extends parallel to the second fold, the second sidewall has a second clasp portion that has a length that extends parallel to the second fold, and the length of the second clasp portion extends at least 30 percent of the length of the second sidewall, the first clasp portion being a male clasp portion formed from the unitary sheet and integral to the first box portion, and the second clasp portion being a female slot disposed in the second box portion.

12. A blank for constructing a box having a total inner volume in a closed configuration, the blank comprising:
a unitary sheet of sheetstock material having:
a first blank portion; and
a second blank portion that is integral to the first blank portion and pivotable relative to the first blank portion about a living clamshell hinge disposed along a border shared by the first and second blank portions,
wherein each of the first and second blank portions has a center panel, a first side panel integrally formed with the center panel along a first panel fold, a second side panel integrally formed with the center panel along a second panel fold disposed opposite the center panel from the first panel fold, a first locker flap integrally formed with the center panel along a first flap fold that extends from the first panel fold to the second panel fold, a second locker flap integrally formed with the center panel along a second flap fold disposed opposite the center panel from the first flap fold, a first blocker flap integrally formed with one of the first or second side panels along a third flap fold that is parallel to the first flap fold, and a second blocker flap integrally formed with one of the first or second side panels along a fourth flap fold that is parallel to the second flap fold,
wherein each locker flap has a blocker fold, a proximal portion that extends from a corresponding one of the first or second flap folds of a corresponding one of the first or second blank portions to the blocker fold, and a distal portion opposite the blocker fold from the proximal portion, the blocker fold being offset from the corresponding flap fold by a first distance,
wherein each blocker flap corresponds to one of the first or second locker flaps of one of the first or second blank portions and has a blocker edge that is an edge of the blocker flap that is farthest offset from the corresponding locker flap, the blocker edge being offset from the corresponding locker flap by a second distance along a dimension that is parallel to a corresponding one of the third or fourth flap folds of the corresponding blank portion, the second distance matching the first distance of the corresponding locker flap, and
wherein the first and second blank portions are sized and dimensioned to respectively form a first box portion and a second box portion that is pivotable relative to the first box portion about the living clamshell hinge, the first box portion defining a first inner volume, the second box portion defining a second inner volume, and the first and second inner volumes combining to provide the total inner volume with each of the first and second volumes providing at least 30 percent of the total inner volume.

13. The blank of claim 12, wherein the first side panel of a first one of the first or second blank portions is integrally formed with the first side panel of a second one of the first or second blank portions along the living clamshell hinge, the living clamshell hinge is offset from the first panel fold of the first one of the first or second blank portions by a third distance, the living clamshell hinge is offset from the first panel fold of the second one of the first or second blank portions by a fourth distance, the third distance matches the first distance of the first one of the first or second blank portions, and the fourth distance matches the first distance of the second one of the first or second blank portions.

14. The blank of claim 12, wherein the first and second panel folds are parallel to the living clamshell hinge, and the first, second, third, and fourth flap folds are perpendicular to the living clamshell hinge.

15. The blank of claim 12, wherein each of the first and second blank portions has two locker tab slots, and each locker flap has a locker tab that is positioned, sized, and dimensioned to be received in a corresponding one of the two locker tab slots of a corresponding one of the first or second blank portions.

16. The blank of claim 12, wherein each locker flap has a finger hole, a diameter of the finger hole is disposed along the blocker fold of the locker flap, and each blocker flap has a quarter finger hole that intersects the blocker edge of the blocker flap.
